(19) United States
(12) Patent Application Publication
(10) Pub. No.: US 2014/0247333 A1
(43) Pub. Date: Sep. 4, 2014

(54) ENDOSCOPE AND METHOD FOR MANUFACTURING THE SAME

(71) Applicant: OLYMPUS MEDICAL SYSTEMS CORP., Tokyo (JP)

(72) Inventor: Masahiro MIZUNO, Tokyo (JP)

(73) Assignee: OLYMPUS MEDICAL SYSTEMS CORP., Tokyo (JP)

(21) Appl. No.: 14/202,048

(22) Filed: Mar. 10, 2014

Related U.S. Application Data
(63) Continuation of application No. PCT/JP2013/077636, filed on Oct. 10, 2013.

(30) Foreign Application Priority Data
Dec. 17, 2012 (JP) 2012-275131

(51) Int. Cl. G02B 23/24

(52) U.S. Cl. CPC G02B 23/243
USPC 348/65; 29/464

(57) ABSTRACT

An endoscope includes an objective optical system fixed in an observation window provided in a distal end portion main body of the endoscope, an imaging optical system configured to form an image of light incident via the objective optical system and to cause the light to be incident on an imaging element, a ring-shaped member whose outer periphery is circular and in which at least a part of the imaging optical system is arranged on an inner periphery of the ring-shaped member, with an optical axis of the imaging optical system being eccentric with respect to a central axis of the outer periphery, and a frame body in which a through hole that has a long hole shape having a diameter in a minor axis direction thereof equal to an outer diameter of the ring-shaped member is provided and the ring-shaped member is fitted into the through hole.

### CROSS REFERENCES TO RELATED APPLICATIONS

This application is a continuation of PCT international application Ser. No. PCT/JP2013/077636 filed on Oct. 10, 2013 which designates the United States, incorporated herein by reference, and which claims the benefit of priority from Japanese Patent Application No. 2012-275131, filed on Dec. 17, 2012, incorporated herein by reference.

### BACKGROUND OF THE INVENTION

1. Field of the Invention

The present invention relates to an endoscope, and in particular, to a structure of an optical system provided in a distal end portion of the endoscope and to a method of manufacturing the same.

2. Description of the Related Art

In recent years, in the field of medical or industrial endoscopes, electronic endoscopes, in which imaging units including imaging elements such as charge coupled devices are installed inside thereof, are mainly used (for example, see Japanese Patent Application Laid-open No. 2009-273642). In an electronic endoscope, an image of observation light from a subject is formed on a light receiving surface of an imaging element by an objective lens provided in a distal end portion thereof, and an image of the subject is generated. This image is displayed on a display device, such as an external monitor, which is electrically connected to the endoscope.

FIG. 14 is a schematic diagram illustrating an internal structure of a distal end portion of a conventional endoscope. In FIG. 14, a side view type endoscope with an observation direction having an angle with respect to a longitudinal direction of an insertion unit thereof is illustrated. As illustrated in FIG. 14, a distal end portion 90 of the endoscope is provided with an imaging unit 91 integrally formed of an imaging element and an imaging optical system such as a lens, an objective lens 92, and a prism unit 93. Of these, the imaging unit 91 is arranged inside a distal end portion main body 94 with an optical axis thereof being in line with a longitudinal direction of the distal end portion main body 94. The objective lens 92 is arranged at an inner side of an observation window 95 provided at a part of the distal end portion main body 94 and is fixed by an adhesive 96 filled in a clearance from the observation window 95. The prism unit 93 bends light incident from the objective lens 92 along an optical path L9 into a direction of an optical path L8 and causes the light to be incident on the imaging unit 91.

FIG. 15 is a schematic diagram of the observation window 95 and the objective lens 92 that are illustrated in FIG. 14, which are viewed from a direction of the optical path L9 of the objective lens 92. Conventionally, the distal end portion of the endoscope is assembled as described below. First, in the distal end portion main body 94, the imaging unit 91 and the prism unit 93 are installed. Subsequently, the objective lens 92 is arranged in the observation window 95 and the objective lens 92 is moved in a movable range of the observation window 95 to perform centering (alignment of optical axes) with respect to the imaging unit 91. Thereafter, in the clearance between the objective lens 92 and the observation window 95 that have been subjected to the centering, the adhesive 96 (see FIG. 14) is filled and hardened.

### SUMMARY OF THE INVENTION

An endoscope according to one aspect of the invention includes: an objective optical system fixed in an observation window provided in a distal end portion main body of the endoscope; an imaging optical system configured to form an image of light incident from outside of the distal end portion main body via the objective optical system and to cause the light to be incident on an imaging element; a ring-shaped member whose outer periphery is circular and in which at least a part of the imaging optical system is arranged on an inner periphery of the ring-shaped member in a state in which an optical axis of the imaging optical system is eccentric with respect to a central axis of the outer periphery; and a frame body in which a through hole that has a long hole shape having a diameter in a minor axis direction thereof equal to an outer diameter of the ring-shaped member is provided and the ring-shaped member is fitted into the through hole with an outer peripheral surface of the ring-shaped member serving as a fitting surface.

A method of manufacturing an endoscope according to another aspect of the invention includes the steps of: fixing an objective optical system in an observation window provided in a distal end portion main body of the endoscope; and arranging, in the distal end portion main body, an imaging optical system that forms an image of light incident from outside of the distal end portion main body via the objective optical system and causes the light to be incident on an imaging element. The arranging of the imaging optical system in the distal end portion main body includes the steps of: arranging at least a part of the imaging optical system on an inner periphery of a ring-shaped member having a circular outer periphery in a state in which an optical axis of the imaging optical system is eccentric with respect to a central axis of the outer periphery; fitting, with respect to a frame body in which a through hole that has a long hole shape having a diameter in a minor axis direction thereof equal to an outer diameter of the ring-shaped member is provided, the ring-shaped member into the through hole, with an outer peripheral surface of the ring-shaped member serving as a fitting surface; and aligning the optical axis of the imaging optical system with an optical axis of the objective optical system by performing at least one of: rotating the ring-shaped member with respect to the frame body; and moving the ring-shaped member parallel with a major axis direction of the long hole shape.

The above and other features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a diagram illustrating a schematic structure of an endoscope according to an embodiment of the present invention;

FIG. 2 is a schematic diagram illustrating an internal structure of a distal end portion illustrated in FIG. 1;

FIG. 3 is a schematic diagram illustrating a cross section of a distal end portion main body along a dashed line A-A illustrated in FIG. 2;

FIG. 4 is a front view of an eccentric ring illustrated in FIG. 2;

FIG. 5 is a schematic diagram illustrating a cross section of a part of the eccentric ring, of the distal end portion illustrated in FIG. 2;

FIG. 6 is a side view illustrating a part of an appearance of the distal end portion main body;

FIG. 7 is a cross section diagram of the distal end portion along a dashed line B-B illustrated in FIG. 6;

FIG. 8 is a cross section diagram of the distal end portion along a dashed line C-C illustrated in FIG. 6;

FIG. 9A is a schematic diagram illustrating a state in which a notch of the eccentric ring has been aligned with respect to a major axis of a lens frame accommodation portion;

FIG. 9B is a schematic diagram illustrating a state in which the notch of the eccentric ring has been rotated by 90 degrees with respect to the major axis of the lens frame accommodation portion;

FIG. 9C is a schematic diagram illustrating a state in which the notch of the eccentric ring has been rotated by 180 degrees with respect to the major axis of the lens frame accommodation portion;

FIG. 9D is a schematic diagram illustrating a state in which the notch of the eccentric ring has been rotated by 270 degrees with respect to the major axis of the lens frame accommodation portion;

FIG. 10 is a schematic diagram illustrating a state in which the eccentric ring has been moved upward along the major axis of the lens frame accommodation portion;

FIG. 11 is a diagram illustrating an adjustable range of an optical axis of an imaging unit;

FIG. 12A is a front view illustrating an eccentric ring according to a first modified example of the embodiment of the present invention;

FIG. 12B is a side view illustrating the eccentric ring according to the first modified example of the embodiment of the present invention;

FIG. 13A is a front view illustrating an eccentric ring according to a second modified example of the embodiment of the present invention;

FIG. 13B is a side view illustrating the eccentric ring according to the second modified example of the embodiment of the present invention;

FIG. 14 is a schematic diagram illustrating a structure of a distal end portion of a conventional endoscope; and

FIG. 15 is a schematic diagram of an objective lens unit illustrated in FIG. 14 viewed from an optical axis direction.

### DETAILED DESCRIPTION OF THE PREFERRED EMBODIMENTS

Hereinafter, endoscopes according to embodiments of the present invention will be described with reference to the drawings. The present invention is not limited by these embodiments. Further, in describing the drawings, the same portions are appended with the same reference signs.

### Embodiments

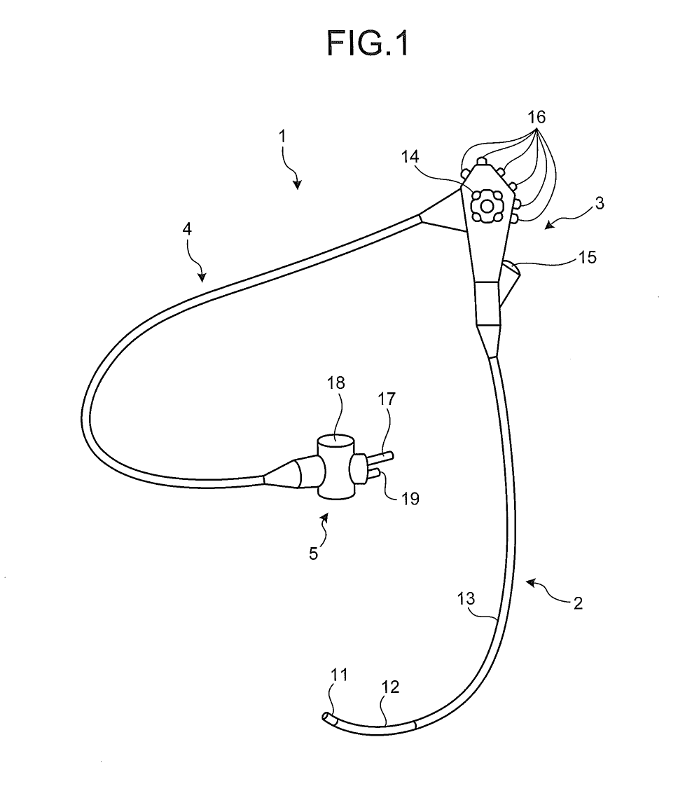

FIG. 1 is a diagram illustrating a schematic structure of an endoscope according to an embodiment of the present invention. As illustrated in FIG. 1, an endoscope 1 according to the embodiment includes: an insertion unit 2 that has flexibility and is elongated; an operating unit 3 that is connected to a proximal end side of the insertion unit 2 and grasped by an operator of the endoscope 1; a universal cord 4 that extends from a lateral portion of this operating unit 3 and is flexible; and a connector unit 5 that is provided at an extending side end portion of the universal cord 4 and performs transmission and reception of an electric signal and an optical signal with a signal processing apparatus and a light source device that are not illustrated.

The insertion unit 2 includes: a distal end portion 11 having an imaging module built-in therein, the imaging module having an imaging element such as a CCD; a bending portion 12 that is formed of a plurality of bending pieces and freely bendable; and a flexible tube portion 13 that is provided at a proximal end side of this bending portion 12, is long, and has flexibility.

The operating unit 3 is provided with a bending knob 14 that bends the bending portion 12 in a vertical direction and a horizontal direction, a treatment tool insertion portion 15 through which a treatment tool such as biopsy forceps or a laser probe is configured to be inserted in a body cavity, and a plurality of switches 16 that executes operation of peripheral devices such as the signal processing apparatus and a control device, or, air feeding, water feeding, and gas feeding means. In the endoscope 1 in which the treatment tool has been inserted through a treatment tool insertion opening, a distal end treatment portion of the treatment tool is protruded via a treatment tool insertion channel provided inside thereof, and biopsy or the like of obtaining affected tissue by the biopsy forceps, for example, is performed.

The universal cord 4 has a light guide cable, an electrical cable, and the like, built-in therein.

The connector unit 5 is provided with a light guide connector 17 configured to be detachably connected to the light source device, an electric contact portion 18 for transmitting an electrical signal of a subject image photoelectrically converted by the imaging element to the signal processing apparatus, and an air feeding mouthpiece 19 or the like for feeding air into a nozzle of the distal end portion 11.

The light source device supplies light from a halogen lamp or the like built-in therein to the endoscope 1 connected via the light guide connector 17, as illumination light. The signal processing apparatus is an apparatus, which supplies power to the later described imaging element, and in which the electrical signal photoelectrically converted by the imaging element is input, and the signal processing apparatus processes the electrical signal and causes the display device to display an image and performs control such as gain adjustment of the imaging element and outputting of a drive signal that drives the imaging device.

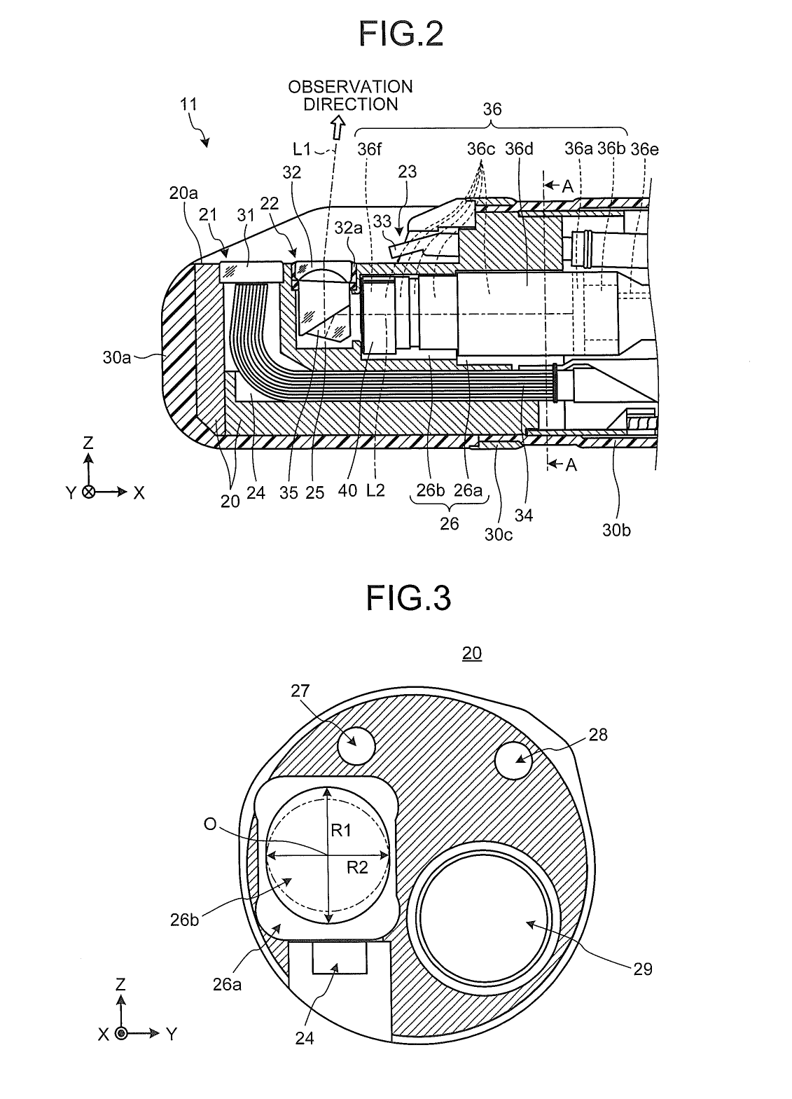

FIG. 2 is a schematic diagram illustrating an internal structure of the distal end portion 11. In the distal end portion 11, a distal end portion main body 20, which is formed of a hard material such as a metal, is provided. The distal end portion main body 20 has an appearance in which a part of a cylinder has been notched off and is a frame body in which openings and through holes for accommodating various built-in units are provided inside. FIG. 3 is a diagram illustrating a cross section of the distal end portion main body 20 along a dashed line A-A of FIG. 2.

As illustrated in FIG. 2 and FIG. 3, an outer peripheral flat surface portion 20a of the distal end portion main body 20 is provided with an illumination window 21 in which an illumination lens 31 is fitted, an observation window 22 in which an objective lens 32 is fitted, an opening portion 23 through which an air feeding and water feeding nozzle 33 is configured to be inserted, and an opening portion (not illustrated) through which the treatment tool such as the forceps (not illustrated) is exposed to outside.

Inside the distal end portion main body 20, provided are a light guide accommodation unit 24 which communicates with the illumination window 21 and through which a light guide 34 is configured to be inserted, a prism unit accommodation unit 25 that communicates with the observation window 22 and accommodates a prism unit 35, an imaging unit accommodation unit 26 that communicates with the prism unit accommodation unit 25 and accommodates an imaging unit 36, an air feeding channel 27, a water feeding channel 28, and a treatment tool channel 29 through which the treatment tool is configured to be inserted.

The distal end portion main body 20 as described, excluding the outer peripheral flat surface portion 20a, is covered by a distal end cover 30a formed of a soft material such as a resin. Further, a back end of the distal end cover 30a is: connected to an insertion unit cover 30b, which covers the bending portion 12 (see FIG. 1) and is soft; and fixed by a spool adhesive portion 30c.

A structure of an endoscope having an observation direction at an angle slanted by approximately 90° with respect to a longitudinal direction of the distal end portion 11 is called “side view type”. Further, hereinafter, the longitudinal direction of the distal end portion main body 20 is referred to as “X-direction”, and a direction orthogonal to the outer peripheral flat surface portion 20a where the illumination window 21 and the observation window 22 are provided is referred to as “Z-direction”.

Next, a structure and functions of each part accommodated in the distal end portion main body 20 will be described.

The illumination lens 31 irradiates light supplied from the light guide 34 towards the subject. The light guide 34 is formed of a glass fiber bundle or the like, and propagates white light or special light supplied from the light source device such as the halogen lamp.

The objective lens 32 is fixed to the observation window 22 by an adhesive 32a or the like, and converges light incident from outside of the distal end portion main body 20. In FIG. 2, although the objective lens 32 is provided alone, an objective lens unit, which is integrated of a plurality of optical systems such as a lens, a flare diaphragm, and the like, may be provided.

The prism unit 35 is a bending optical system that bends light, which has passed through the objective lens 32 along an optical path L1 from a subject side, and causes the light to advance in a longitudinal direction of the distal end portion main body 20 (a direction of an optical path L2).

The imaging unit 36 is an imaging optical system, in which an imaging element 36a such as a CCD, a circuit board 36b on which a drive circuit or the like that drives the imaging element 36a is mounted, and a plurality of optical members 36c such as a lens, a diaphragm, and the like, are integrally provided. Of these, the plurality of optical members 36c are fixed by a holder (lens frame) 36d that is tubular, with optical axes thereof in alignment with one another, and forms an image of light incident via the objective lens 32 and the prism unit 35 on a light receiving surface of the imaging element 36a.

In the imaging unit 36 described, the optical axes of the optical members 36c are arranged to be generally along a central axis of the distal end portion main body 20. Further, the imaging unit 36 transmits an electrical signal (image signal) output by the imaging element 36a to the signal processing apparatus, and is connected to the signal processing apparatus via a cable assembly 36e that transmits a control signal and a drive signal output by the signal processing apparatus to the imaging element 36a.

A distal end portion 36f of the lens frame 36d of the imaging unit 36 is fitted in an inner periphery of the eccentric ring 40. The imaging unit 36 is attached to the imaging unit accommodation unit 26 of the distal end portion main body 20, via this eccentric ring 40. In this embodiment, only the distal end portion 36f of the lens frame 36d is fitted in the eccentric ring 40, but the eccentric ring 40 may be made longer so that the lens frame 36d is able to be more stably held at the inner periphery of the eccentric ring 40.

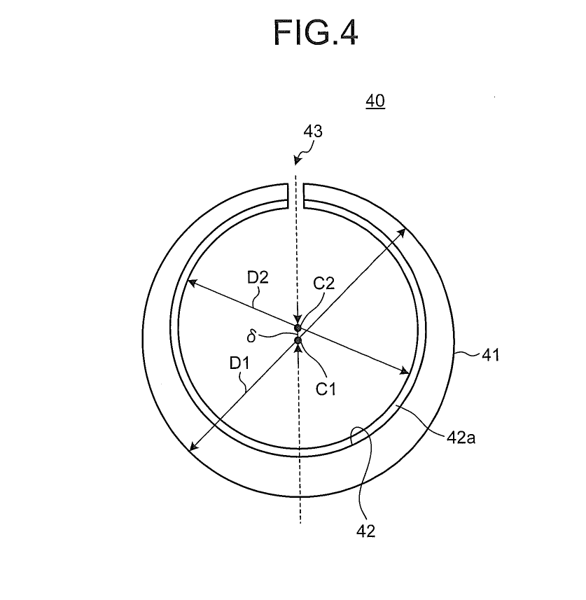

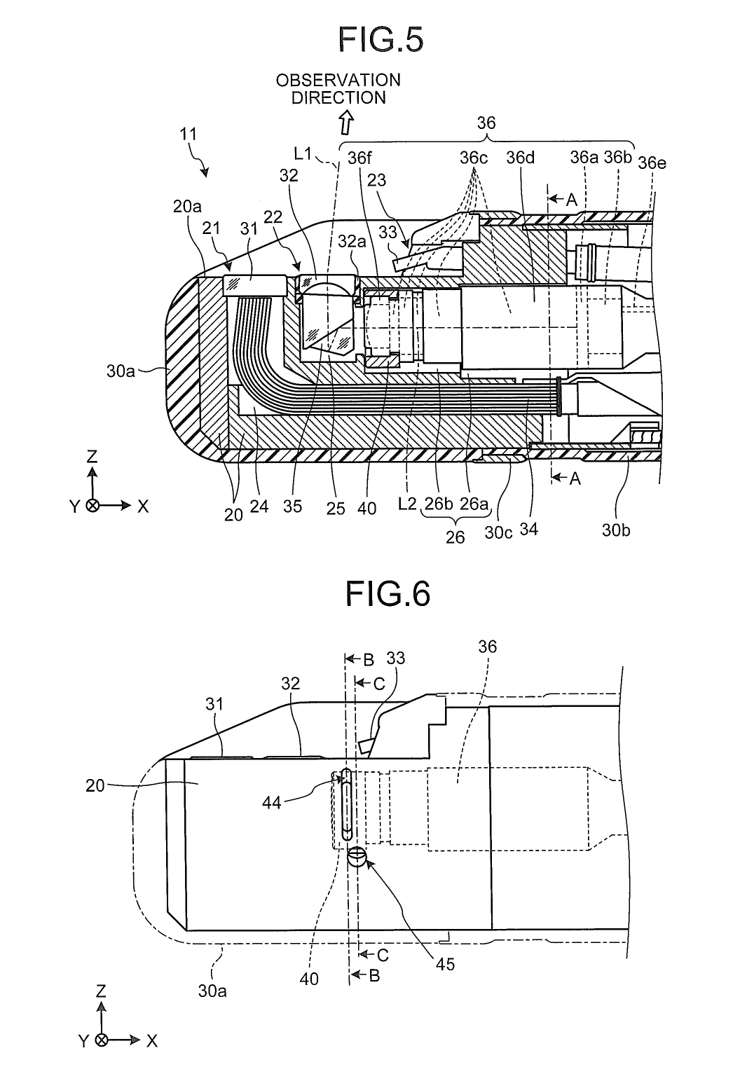

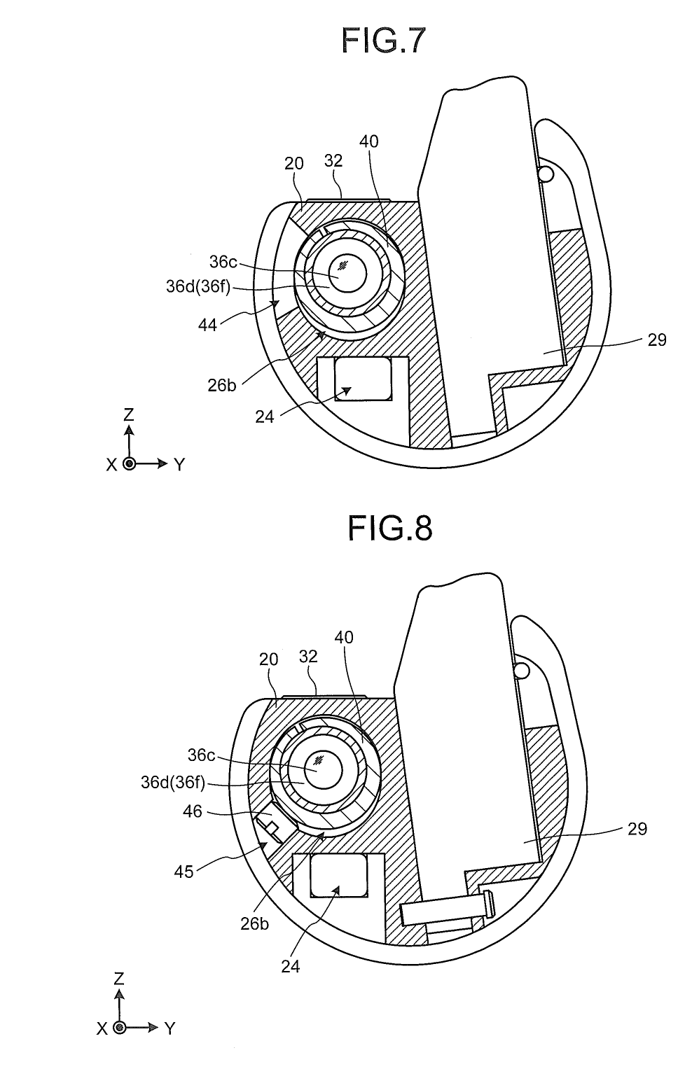

Next, an attachment structure of the imaging unit 36 to the distal end portion main body 20 will be described in detail with reference to FIG. 2 to FIG. 8. FIG. 4 is a front view of the eccentric ring 40. FIG. 5 is a schematic diagram illustrating a cross section of a part of the eccentric ring 40, of the distal end portion 11 illustrated in FIG. 2. FIG. 6 is a side view illustrating a part of an appearance of the distal end portion main body 20. FIG. 7 is a cross section diagram of the distal end portion 11 along a dashed line B-B illustrated in FIG. 6. FIG. 8 is a cross section diagram of the distal end portion 11 along a dashed line C-C illustrated in FIG. 6.

As illustrated in FIG. 2, the imaging unit accommodation unit 26 has a two step structure, and a diameter of a lens frame accommodation portion 26b that accommodates the lens frame 36d at a distal end of the imaging unit 36 is smaller than a diameter of a main body accommodation portion 26a that accommodates the imaging element 36a and the circuit board 36b.

As illustrated in FIG. 3, the lens frame accommodation portion 26b is a through hole whose cross section has a long hole shape. The lens frame accommodation portion 26b is formed to have an orientation such that a central axis O of the lens frame accommodation portion 26b is parallel to the X-direction, a major axis R1 is parallel to the Z-direction, and a minor axis R2 is parallel to a Y-direction.

As illustrated in FIG. 4, the eccentric ring 40 is a columnar member having an outer peripheral portion 41 and an inner peripheral portion 42, which are both circular, and the eccentric ring 40 is formed of a hard material such as a metal. A diameter D1 of the outer peripheral portion 41 is substantially equal to a minor axis R2 direction diameter of the lens frame accommodation portion 26b. Further, a diameter D2 of the inner peripheral portion 42 (D2<D1) is substantially equal to that of an outer periphery of the distal end portion 36f of the lens frame 36d. Further, a central axis C2 of the inner peripheral portion 42 is eccentric with respect to a central axis C1 of the outer peripheral portion 41 by a length (eccentric distance) “δ”. In this embodiment, to facilitate work of fitting the eccentric ring 40 in the distal end portion 36f of the lens frame 36d, a notch 43 that cuts a part of the ring is provided, but the notch 43 is not essential. Further, in this embodiment, at one of end portions of the inner peripheral portion 42, a convex portion 42a is provided, which is formed by making a part of an inner surface thereof protrude towards an inner peripheral side.

As illustrated in FIG. 5, in the eccentric ring 40, the distal end portion 36f of the lens frame 36d is fitted in the inner peripheral portion 42 and the outer peripheral portion 41, which serves as a fitting surface, is fitted in the lens frame accommodation portion 26b. By both extending the eccentric ring 40 in an axial direction and providing a step conforming to a shape of the lens frame 36d on the inner peripheral portion 42, the eccentric ring 40 may be caused to be able to stably hold, not only the distal end portion 36f of the lens frame 36d, but also a wider area of the lens frame 36d.

As illustrated in FIG. 6, in a region opposite to the eccentric ring 40 on an outer peripheral surface of the distal end portion main body 20, through holes 44 and 45, which communicate with the lens frame accommodation portion 26b, are provided.

The through hole 44 has a long hole shape, and as illustrated in FIG. 7, is provided such that the longitudinal direction thereof is along a circumferential direction of the distal end portion main body 20. By inserting a pin or the like in this through hole 44 and operating the pin by contacting the pin with a lateral surface of the eccentric ring 40, the eccentric ring 40 is rotatable with respect to the central axis C1.

On an inner periphery of the through hole 45, a female screw is provided, and as illustrated in FIG. 8, inside the through hole 45, a screw 46, which serves as a fixing member that is screwed together with the through hole 45, is arranged. By tightening the screw 46 and pressing the screw 46 onto the eccentric ring 40, the eccentric ring 40 is able to be fixed with respect to the lens frame accommodation portion 26b.

Next, a method of assembling the distal end portion 11 will be described.

First, the prism unit 35 is inserted into the prism unit accommodation unit 25 of the distal end portion main body 20 and a position thereof is fixed by using a non-illustrated adhesive or the like.

Subsequently, the objective lens 32 is arranged in the observation window 22 and fixed by using the adhesive 32a. When this is done, the objective lens 32 is positioned, such that incident light that has passed through an optical axis of the objective lens 32 is bent by the prism unit 35 and generally passes the central axis O of the imaging unit accommodation unit 26.

The eccentric ring 40 is fitted into the distal end portion 36f of the lens frame 36d of the imaging unit 36. Thereby, an optical axis of the imaging unit 36 is in line with the central axis C2 of the inner peripheral portion 42 of the eccentric ring 40. The imaging unit 36 is inserted in the imaging unit accommodation unit 26 from a lens frame 36d side and the eccentric ring 40 is fitted in the lens frame accommodation portion 26b.

Subsequently, centering of aligning the optical axis of the imaging unit 36 with the optical axis of the objective lens 32 is performed.

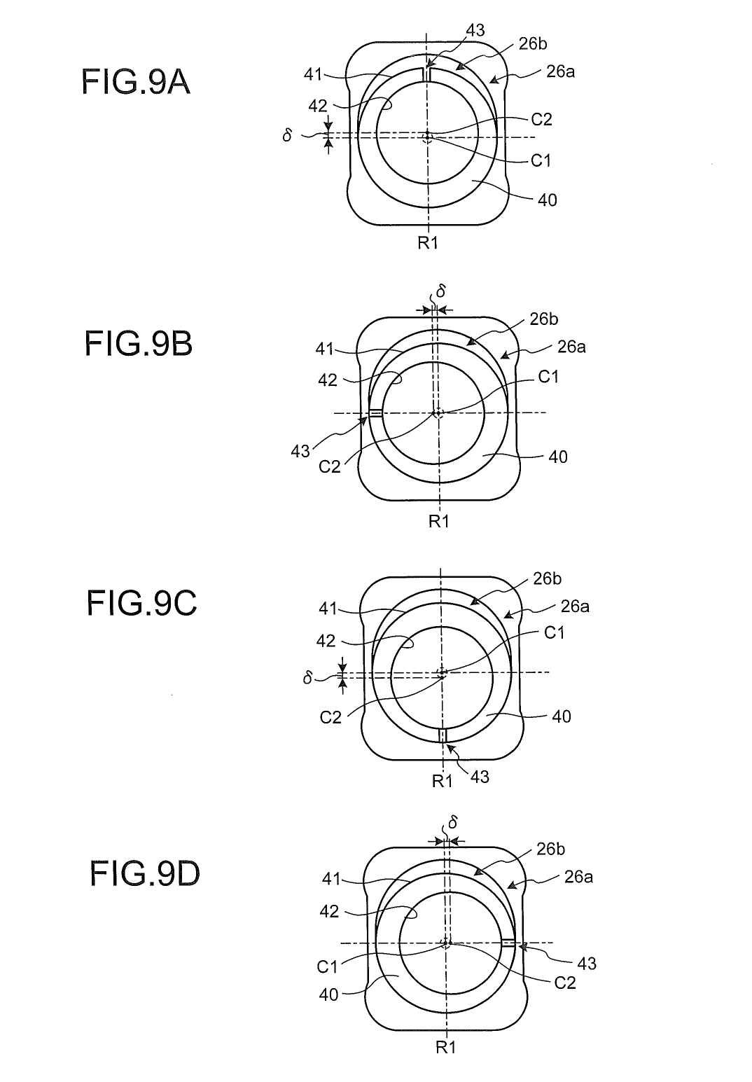

As illustrated in FIG. 9A to FIG. 9D, when the eccentric ring 40 is rotated in the lens frame accommodation portion 26b, the central axis C2 of the inner peripheral portion 42, that is, the optical axis of the imaging unit 36, moves on a circumference, which has a radius equal to the eccentric distance δ, about the central axis C1 of the outer peripheral portion 41. FIG. 9A to FIG. 9D respectively illustrate states in which a position of the notch 43 has been rotated, with respect to the major axis R1 of the lens frame accommodation portion 26b, by 0 degrees, 90 degrees, 180 degrees, and 270 degrees. In FIG. 9A to FIG. 9D, illustration of the convex portion 42a (see FIG. 4) is omitted.

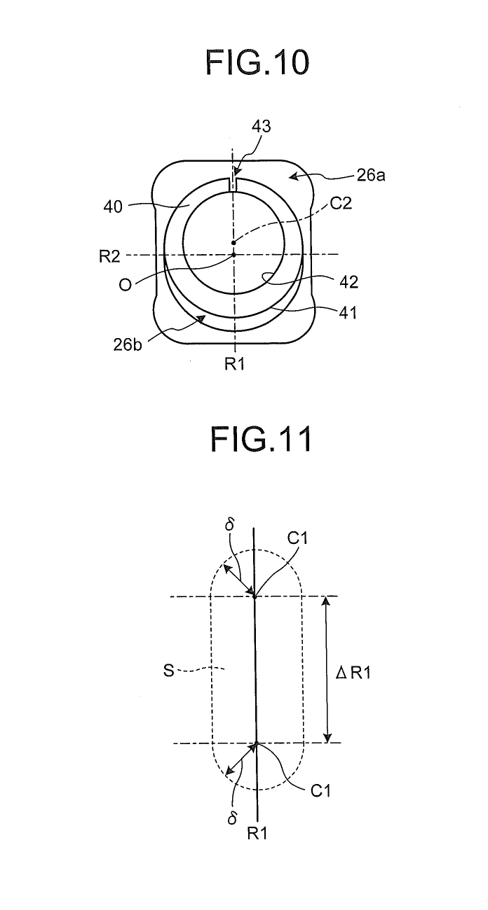

As illustrated in FIG. 10, when the eccentric ring 40 is moved parallel with the major axis R1 of the lens frame accommodation portion 26b, the central axis C2 of the inner peripheral portion 42 similarly moves parallelly.

As described, by combining the rotation and the parallel movement of the eccentric ring 40, as illustrated in FIG. 11, the optical axis of the imaging unit 36 is adjustable within: a movable range ΔR1 in a major axis R1 direction of the central axis C1 of the outer peripheral portion 41; and an area S surrounded by semicircles respectively having centers at an upper limit position and a lower limit position of the central axis C1 and having radii both equal to the eccentric distance δ.

In a specific method of aligning the optical axes, for example, an image of light incident on the imaging unit 36 via the objective lens 32 and the prism unit 35 from outside of the observation window 22 is displayed on the display device (not illustrated) based on an image signal output from the imaging unit 36. While rotating and parallelly moving the eccentric ring 40 by using the pin or the like inserted from the through hole 44, the orientation and the position of the eccentric ring 40 may be determined such that the optical axis of the imaging unit 36 comes to a center of an image display area.

After aligning the optical axis of the imaging unit 36, subsequently, the screw 46 that is screwed together with the through hole 45 is tightened to fix the eccentric ring 40.

Further, by covering, with the distal end cover 30a, a region of the distal end portion main body 20 excluding the outer peripheral flat surface portion 20a, the distal end portion 11 is completed.

As described above, according to the embodiment, after fixing the objective lens 32 to the distal end portion main body 20, centering of the imaging unit 36 with respect to the objective lens 32 is performed. Accordingly, trouble and time to fix the objective lens with an adhesive after centering become unnecessary and displacement after the centering is able to be suppressed. Therefore, accuracy of centering is able to be improved. In particular, in the embodiment, by using the screw 46, a state in which the imaging unit 36 has been aligned is able to be fixed easily and quickly.

Further, according to the embodiment, by adjusting the eccentric distance δ of the eccentric ring 40 or the movable range ΔR1 of the central axis C1 of the outer peripheral portion 41 in the major axis R1 direction of the lens frame accommodation portion 26b, the adjustable range of the optical axis of the imaging unit 36 is settable as appropriate and the optical axis of the imaging unit 36 is freely adjustable within that range.

Further, according to the embodiment, a problem that a field becomes fogged because of steam in a cleaning and sterilizing step of an endoscope entering inside an observation window and the steam becoming condensed on an inner surface of the observation window during use of the endoscope, is also able to be solved.

In a conventional endoscope, because a large clearance from an observation window is taken for aligning an objective lens unit, a region to be filled in by an adhesive is also large. Accordingly, in a cleaning and sterilizing step of the endoscope, moisture sometimes enters inside the observation window from the region filled in with the adhesive. If such an endoscope is inserted in a living body, a problem that the objective lens unit is fogged by the moisture in the observation window occurs. However, according to the embodiment, because a clearance between an objective lens unit and an observation window is able to be reduced more than conventionally, entrance of moisture from a region filled in with an adhesive is preventable, and a good usage state of an endoscope is maintainable for a long period of time.

In the above described embodiment, although an example of applying the present invention to a side view type endoscope has been described, the present invention is also applicable to a direct view type endoscope in which a longitudinal direction of a distal end portion and an observation direction match each other, or to an oblique view type endoscope in which an observation direction is slanted with respect to a longitudinal direction of a distal end portion.

### First Modified Example

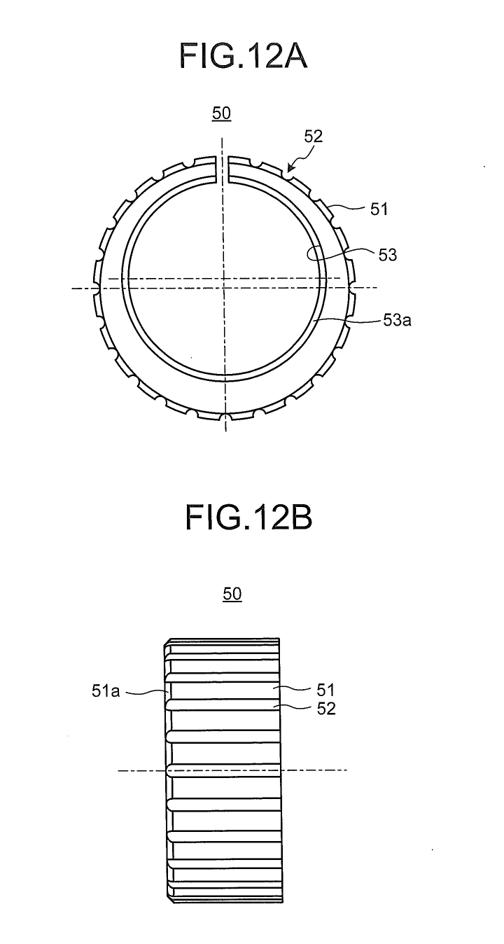

FIG. 12A is a front view illustrating an eccentric ring according to a first modified example of the embodiment. Further, FIG. 12B is a side view of the eccentric ring illustrated in FIG. 12A. As illustrated in FIG. 12A and FIG. 12B, an eccentric ring 50 according to the first modified example has: an outer peripheral portion 51 on which grooves 52 are formed periodically; and an inner peripheral portion 53 that is eccentric with respect to the outer peripheral portion 51. In the first modified example, a chamfered portion 51a, which is formed by chamfering one of end portions of the outer peripheral portion 51, is provided, and at one of end portions of the inner peripheral portion 53, a convex portion 53a, which is formed of a part of an inner surface thereof being protruded towards an inner periphery side, is also provided.

When the grooves 52 are provided on the outer peripheral portion 51 like this first modified example, work upon the rotation and parallel movement of the eccentric ring 50 by inserting the pin or the like from the through hole 44 (see FIG. 6) becomes easy. Further, the eccentric ring 50 is able to be more stably fixed by the screw 46.

### Second Modified Example

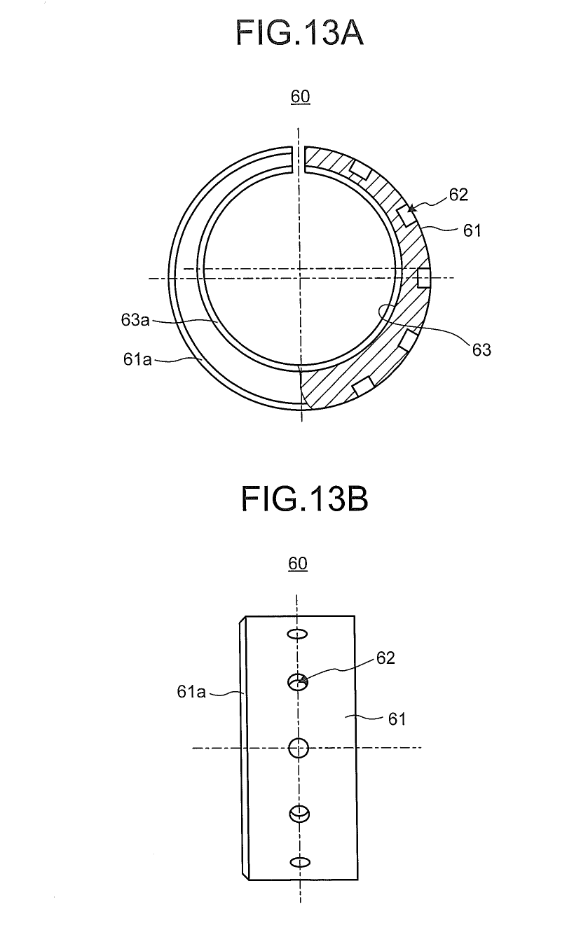

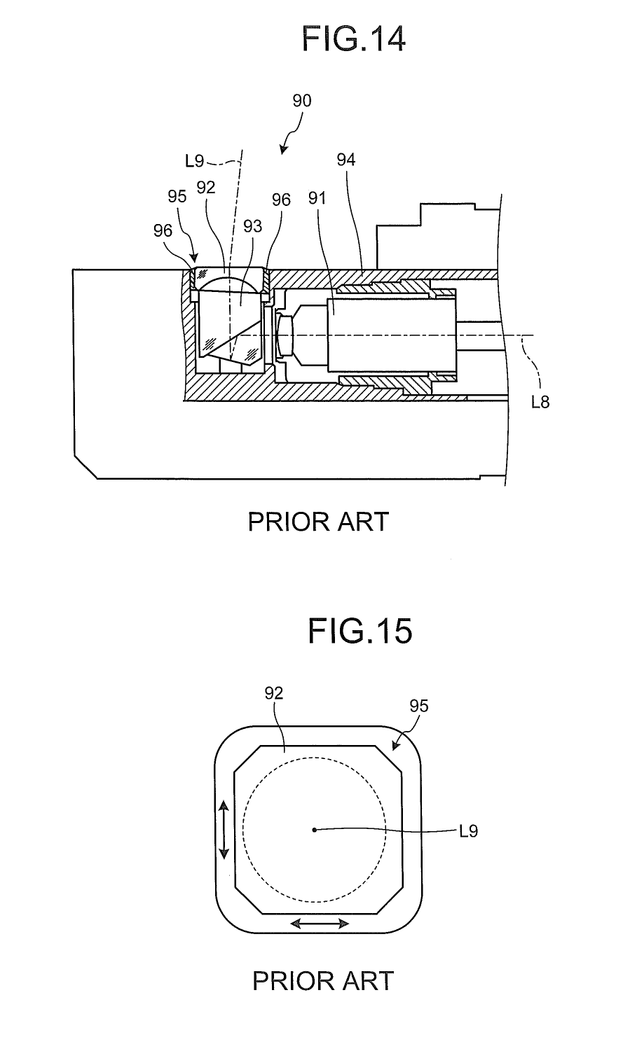

FIG. 13A is a front view illustrating an eccentric ring according to a second modified example of the embodiment. Further, FIG. 13B is a side view of the eccentric ring illustrated in FIG. 13A. As illustrated in FIG. 13A and FIG. 13B, an eccentric ring 60 according to the second modified example has: an outer peripheral portion 61 on which concave portions 62 are formed periodically; and an inner peripheral portion 63 that is eccentric with respect to the outer peripheral portion 61. In the second modified example, a chamfered portion 61a, which is formed by chamfering one of end portions of the outer peripheral portion 61, is provided, and on one of end portions of the inner peripheral portion 63, a convex portion 63a, which is formed of a part of an inner surface thereof being protruded towards an inner periphery side, is also provided.

When the concave portions 62 are provided on the outer peripheral portion 61 like this second modified example, work upon the rotation and parallel movement of the eccentric ring 60 by inserting the pin or the like from the through hole 44 becomes easy.

Besides the above described first and second modified examples, as long as the imaging unit 36 is able to be held in a state in which the optical axis of the imaging unit 36 is eccentric with respect to a central axis of an outer periphery, other members may be employed instead of a ring-shaped member. Or, a thickness of the lens frame 36d may be changed in a circumferential direction such that the optical axes of the plurality of optical members 36c are eccentric with respect to a central axis of an outer periphery of the lens frame 36d that holds the optical members 36c. In that case, with an outer peripheral surface of the lens frame 36 serving as a fitting surface, the lens frame 36d is directly fitted in the lens frame accommodation portion 26b.

As described above, according to the embodiments of the present invention and the modified examples thereof, by rotating a ring-shaped member in a through hole provided in a frame body, or by moving the ring-shaped member along a major axis of the through hole, a position of an optical axis of an imaging optical system fitted in the ring-shaped member is able to be adjusted easily and stably. Therefore, with respect to an objective optical system fixed in a distal end portion main body, centering of the imaging optical system is able to be performed easily and accurately.

The present invention is not limited to the embodiments and the modified example but can be embodied in various forms by combining as appropriate a plurality of elements disclosed in relation to the foregoing embodiments and modified example. For example, some of the elements in the foregoing embodiments and modified example may be eliminated, or elements in the different embodiments and modified example may be combined as appropriate. It will be obvious to those skilled in the art based upon the foregoing teachings that changes and modifications may be made according to specifications and various other embodiments may be realized without departing from the scope of the invention.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An endoscope, comprising:
an objective optical system fixed in an observation window provided in a distal end portion main body of the endoscope;
an imaging optical system configured to form an image of light incident from outside of the distal end portion main body via the objective optical system and to cause the light to be incident on an imaging element;
a ring-shaped member whose outer periphery is circular and in which at least a part of the imaging optical system is arranged on an inner periphery of the ring-shaped member in a state in which an optical axis of the imaging optical system is eccentric with respect to a central axis of the outer periphery; and
a frame body in which a through hole that has a long hole shape having a diameter in a minor axis direction thereof equal to an outer diameter of the ring-shaped member is provided and the ring-shaped member is fitted into the through hole with an outer peripheral surface of the ring-shaped member serving as a fitting surface.

2. The endoscope according to claim 1, wherein the optical axis of the imaging optical system is aligned with an optical axis of the objective optical system.

3. The endoscope according to claim 1, wherein a center of the inner periphery of the ring-shaped member is eccentric with respect to a center of the outer periphery of the ring-shaped member.

4. The endoscope according to claim 1, further comprising
a holder that holds the imaging optical system, wherein
the ring-shaped member is fitted into the holder.

5. The endoscope according to claim 1, wherein
an optical axis direction of the objective optical system and an optical axis direction of the imaging optical system intersect with each other, and
the endoscope further comprises a bending optical system configured to bend the light that has passed through the objective optical system toward a direction of the imaging optical system.

6. The endoscope according to claim 1, further comprising a fixing member that fixes the ring-shaped member to the frame body.

7. A method of manufacturing an endoscope, comprising the steps of:
fixing an objective optical system in an observation window provided in a distal end portion main body of the endoscope; and
arranging, in the distal end portion main body, an imaging optical system that forms an image of light incident from outside of the distal end portion main body via the objective optical system and causes the light to be incident on an imaging element,
wherein the arranging of the imaging optical system in the distal end portion main body comprises the steps of:
arranging at least a part of the imaging optical system on an inner periphery of a ring-shaped member having a circular outer periphery in a state in which an optical axis of the imaging optical system is eccentric with respect to a central axis of the outer periphery;
fitting, with respect to a frame body in which a through hole that has a long hole shape having a diameter in a minor axis direction thereof equal to an outer diameter of the ring-shaped member is provided, the ring-shaped member into the through hole, with an outer peripheral surface of the ring-shaped member serving as a fitting surface; and
aligning the optical axis of the imaging optical system with an optical axis of the objective optical system by performing at least one of: rotating the ring-shaped member with respect to the frame body; and moving the ring-shaped member parallel with a major axis direction of the long hole shape.
